(19) United States
(12) Patent Application Publication
(10) Pub. No.: US 2016/0107543 A1
(43) Pub. Date: Apr. 21, 2016

(54) Bench Seat, in Particular a Rear Bench Seat in a Vehicle

(71) Applicant: Bayerische Motoren Werke Aktiengesellschaft, Muenchen (DE)

(72) Inventor: Reinhard GOY, Peking/Chaoyang District (CN)

(21) Appl. No.: 14/983,656

(22) Filed: Dec. 30, 2015

Related U.S. Application Data
(63) Continuation of application No. PCT/EP2014/064094, filed on Jul. 2, 2014.

(30) Foreign Application Priority Data
Jul. 3, 2013 (DE) 10 2013 213 009.0

(51) Int. Cl. B60N 2/02; B60N 2/01

(52) U.S. Cl. CPC B60N 2/02; B60N 2/01

(57) ABSTRACT

A bench seat, in particular a rear bench seat, in a vehicle, includes at least two seats, wherein each seat has at least one seat part which is delimited by side parts. In order to create a bench seat which enables seat positions which are comfortable as a two-seater or as a three-seater, the seat part is adjustable in such a way that it can be moved from a lowered position, in which the side parts form a lateral guide for the seat part, into a raised position, in which the seat part and the side parts form a substantially planar surface.

### CROSS REFERENCE TO RELATED APPLICATIONS

This application is a continuation of PCT International Application No. PCT/EP2014/064094, filed Jul. 2, 2014, which claims priority under 35 U.S.C. §119 from German Patent Application No. 10 2013 213 009.0, filed Jul. 3, 2013, the entire disclosures of which are herein expressly incorporated by reference.

### BACKGROUND AND SUMMARY OF THE INVENTION

The invention relates to a bench seat, in particular a rear bench seat, in a vehicle, which bench seat has at least two passenger seats, each passenger seat including in each case at least one seat part which is delimited by lateral supports.

Bench seats, in particular rear bench seats, in a vehicle are configured as a rule either as pure two-seaters, as two-seaters with a jump seat or as three-seaters.

Each of these constructions has disadvantages, however. For instance, a pure two-seater does not afford any space for a third person. The seat comfort in the middle is unsatisfactory in the case of a two-seater with a middle jump seat. And, sufficient lateral support is not offered in the case of a three-seater if it is occupied by only one or two passengers, since said bench seats as a rule are of substantially planar configuration. In the case of a two-seater with a middle jump seat, the positioning of child seats is also otherwise problematical as a result of the ergonomic shaping of the two outer passenger seats.

It is therefore an object of the present invention to provide a bench seat of the type mentioned at the outset, which bench seat makes comfortable passenger seat positions possible both as a two-seater and as a three-seater.

According to the invention, in the case of a bench seat, in particular a rear bench seat, in a vehicle, which bench seat has at least two passenger seats, each passenger seat including in each case at least one seat part which is delimited by lateral supports, this object is achieved by virtue of the fact that the seat part can be adjusted such that it can be moved from a lowered position, in which the lateral supports form a lateral guide for the seat part, into a raised position, in which the seat part and the lateral supports form a substantially planar surface.

As a consequence of the configuration according to the invention, either a comfortable two-seater with defined lateral support or a three-seater with space for three passengers can be configured as desired. The positioning of one or more child seats is also facilitated by way of the possible planar configuration of the seat surface.

It is provided according to one advantageous development that a back part is provided which is delimited by lateral supports. The back part can be adjusted in such a way that it can be moved from a lowered position, in which the lateral supports form a lateral guide for the back part, into a raised position, in which the back part and the lateral supports form a substantially planar surface. In this way, stable lateral support is achieved not only in the region of the seat surface, but rather also in the region of the back surface.

Each passenger seat can advantageously be adjusted individually. In this way, only one passenger seat can also be produced with a defined lateral support, for example, whereas the remaining part of the bench seat is substantially planar and, for example, permits the positioning of a child seat.

As an alternative, all the passenger seats can also be adjustable jointly. In this way, there is only the alternative between a comfortable two-seater with defined lateral support or a substantially planar seat surface which can be utilized as a three-seater or in order to place one or more child seats.

According to one preferred refinement, the adjustment takes place by way of an inflatable chamber which is arranged below the seat part and/or below the back part. The inflation can take place manually or else via an electrically operated pump.

As an alternative, a mechanical or electrical mechanism can also make the adjustment possible.

The refinement according to the invention is advantageously realized on the two passenger seats which lie on the outside, with the result that a jump seat can also be provided between the two passenger seats.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a perspective view of a bench seat which is configured according to an embodiment of the invention, in a lowered position, and

FIG. 2 is a perspective view of a bench seat which is configured according to an embodiment of the invention, in a raised position.

### DETAILED DESCRIPTION OF THE DRAWINGS

The figures show a bench seat 1 which is configured according to an embodiment of the invention and is, preferably, the rear bench seat in a vehicle. The figures show only the seat surface (and also only in each case the right-hand seat thereof), but the back surface and the left-hand seat can be configured just like the seat surface and the right-hand seat, respectively.

The bench seat 1 has two passenger seats 2 and 3 which lie on the outside and a jump seat 4 which lies in between.

Each of the passenger seats 2, 3 has at least one seat part 5 and a back part (not shown). Furthermore, at least each seat part 5 is delimited by lateral supports 6.

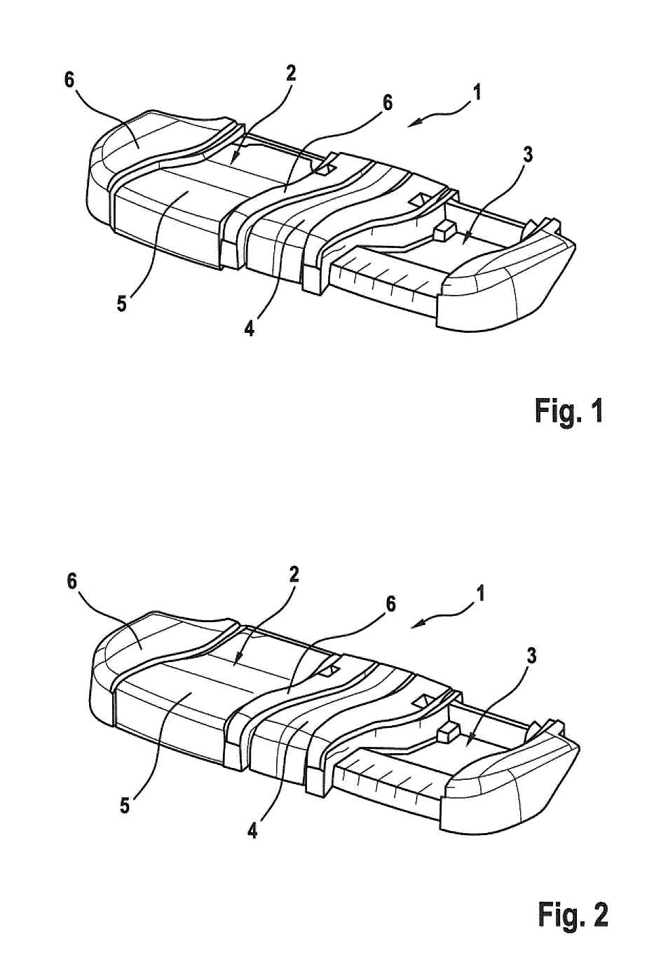

An inflatable chamber (not shown) is arranged below the seat part 5, with the aid of which inflatable chamber the seat part 5 is moved from a lowered position, in which the lateral supports form a lateral guide for the seat part (FIG. 1), into a raised position, in which the seat part 5 and the lateral supports 6 form a substantially planar surface (FIG. 2). Depending on the state, two outer passenger seats 2 and 3 with defined lateral support or a substantially planar seat surface for three passengers or one or more child seats thus result.

The same configuration which is described in the above text for the seat part 5 can also be provided for the back part (not shown).

In this case, an inflatable chamber is also arranged below (or behind) the back part, which inflatable chamber can move the back part from a lowered position, in which the lateral supports form a lateral guide for the back part, into a raised position, in which the back part and the lateral supports form a substantially planar surface.

The passenger seats 2 and 3 can be adjustable either individually or else jointly.

Instead of the described configuration with an inflatable chamber, a mechanical or electrical mechanism can also be provided which makes the adjustment of the seat part 5 and/or the back part possible.

List of Designations

| | |
|---|---|
| 1 | Bench seat |
| 2 | Passenger seat |
| 3 | Passenger seat |
| 4 | Jump seat |
| 5 | Seat part |
| 6 | Lateral support |

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A bench seat in a vehicle, comprising:
at least two passenger seats, each of the passenger seats comprising at least one seat part delimited by lateral supports, wherein
the at least one seat part is adjustable so as to be movable from a lowered position, in which the lateral supports form a lateral guide for the seat part, into a raised position in which the seat part and the lateral supports form a substantially planar surface.

2. The bench seat according to claim 1, further comprising:
a back part associated with the seat part, the back part being delimited by lateral supports, wherein
the back part is adjustable so as to be movable from a lowered position, in which the lateral supports form a lateral guide for the back part, into a raised position in which the back part and the lateral supports form a substantially planar surface.

3. The bench seat according to claim 1, wherein each passenger seat is individually adjustable.

4. The bench seat according to claim 2, wherein each passenger seat is individually adjustable.

5. The bench seat according to claim 1, wherein the at least two passenger seats are jointly adjustable.

6. The bench seat according to claim 2, wherein the at least two passenger seats are jointly adjustable.

7. The bench seat according to claim 1, further comprising:
an inflatable chamber arranged below the seat part.

8. The bench seat according to claim 2, further comprising:
an inflatable chamber arranged below or behind the back part

9. The bench seat according to claim 1, further comprising:
a mechanical or electrical mechanism configured to raise and lower the seat part.

10. The bench seat according to claim 2, further comprising:
a mechanical or electrical mechanism configured to raise and lower the back part

11. The bench seat according to claim 1, further comprising a jump seat arranged between the at least two passenger seats.

12. The bench seat according to claim 1, wherein the bench seat is a rear bench seat in the vehicle.
